(19) United States
(12) Patent Application Publication
(10) Pub. No.: US 2012/0279812 A1
(43) Pub. Date: Nov. 8, 2012

(54) Methods and apparatus for a reconfigurable surface

(76) Inventors: Benjamin Peters, Cambridge, MA (US); Eric Marion, Cambridge, MA (US)

(21) Appl. No.: 13/465,990

(22) Filed: May 7, 2012

Related U.S. Application Data
(60) Provisional application No. 61/482,903, filed on May 5, 2011.

(51) Int. Cl. F16D 59/00; G05B 15/02; F16D 63/00

(52) U.S. Cl. 188/67; 700/275

(57) ABSTRACT

In exemplary implementations of this invention, a pin based mechanism creates physical three dimensional contoured surfaces from a CAD input. When the digital design is downloaded into the device a pin array is collectively actuated to the desired geometry. An optional rubber interpolation layer is held onto the tops of steel pins to prevent undesired dimpling of the surface caused by the discrete nature of the pin array. A single mechanically actuated plate moves all of the pins in the pin array. The device works by pulling all of the closely packed steel pins simultaneously in one direction via a moving plate. As the pins move, they are individually braked and held in position by a phase-changing brake array, integrated with input circuitry. When the plate reaches the end of its stroke, all pins are in the proper configuration.

### RELATED APPLICATIONS

This application claims the benefit of U.S. Provisional Application Ser. No. 61/482903, filed May 5, 2011, the entire disclosure of which is herein incorporated by reference.

### FIELD OF THE TECHNOLOGY

The present invention relates generally to reconfigurable surfaces.

### SUMMARY

In exemplary implementations of this invention, a pin based mechanism creates physical three dimensional contoured surfaces from a computer aided design (CAD) input. When the digital design is downloaded into the device, a pin array is collectively actuated to the desired geometry. An optional rubber interpolation layer is held onto the tops of steel pins to prevent undesired dimpling of the surface caused by the discrete nature of the pin array. A single mechanically actuated plate moves all of the pins in the pin array, regardless of scale or resolution (number of pins or diameter of pins). The device works by pulling all of the closely packed steel pins simultaneously in one direction via a magnetically moving plate. As the pins move, they are individually braked and held in position by a phase-changing brake array, integrated with input circuitry. When the plate reaches the end of its stroke, all pins are in the proper configuration. The simplicity of this actuation method allows for excellent scalability (resolution and area) and low manufacturing cost for the device. In addition, the phase changing brake array, especially when coupled with notched or threaded pins, has an excellent holding strength (about 30 pounds of force for a ⅛″ pin)—allowing for many possible high pressure molding applications on surfaces generated. Another advantage of the actuation technique is that in the “off” state of the machine, the pins are locked in place, so no power is consumed while the device is being used.

In some implementations of this invention, the reconfigurable surface is used as a forming surface, for example, in a mold.

The above description of the present invention is just a summary. It is intended only to give a general introduction to some illustrative implementations of this invention. It does not describe all of the details of this invention. This invention may be implemented in many other ways.

### BRIEF DESCRIPTION OF THE DRAWINGS

FIG. 1 shows an apparatus for creating a reconfigurable surface defined by the position of a plurality of pins.

FIG. 2 shows a simplified side view of the same apparatus.

FIG. 3 shows a cross section of a pin positioning mechanism.

FIG. 4 shows a cross sectional view of a rod positioning apparatus that uses phase-changing brakes.

FIGS. 5 shows how solder can wet to the plating in a PCB (printed circuit board) and lock up the pin when the solder solidifies.

FIG. 6 shows an example where solder does not wet the PCB, but beads up sufficiently to lock the pin in place when the solder solidifies.

FIG. 7 shows a different example, where the solder does not wet the PCBs, but beads up sufficiently to lock the pin in place when the solder solidifies.

FIG. 8 shows an example of a through hole (via) for a pin.

FIG. 9 shows an example where the pin itself is the heating element.

FIG. 10 shows a temperature sensor embedded in a PCB to monitor the temperature of a fusible alloy brake.

FIG. 11 shows a magnetic moving plate for moving an array of ferrite pins.

FIGS. 12A and 12B show a thermally buckling chevron beam. In FIG. 12A, the beam is unheated. In FIG. 12B, the beam is heated.

FIG. 13 shows an example in which the pins themselves comprise the electrical transmission lines through which their corresponding resistor heater receives power.

FIG. 14 is a high level block diagram of a pin-positioning apparatus for creating a forming surface.

The above Figures illustrate some illustrative implementations of this invention, or provide information that relates to those implementations. However, this invention may be implemented in many other ways. The above Figures do not show all of the details of this invention.

### DETAILED DESCRIPTION

In exemplary implementations of this invention, a closely packed array of pins is used for creating high resolution topographical surfaces. For each desired surface, the pins are positioned so that the tips of the pins align with points in (or a certain distance from) the desired surface. The pin positioning technology is scalable to very small pin sizes (1 mm or less) in arrays of nearly unlimited size. It has many practical applications, including vacuum forming, injection molding, and other casting methods.

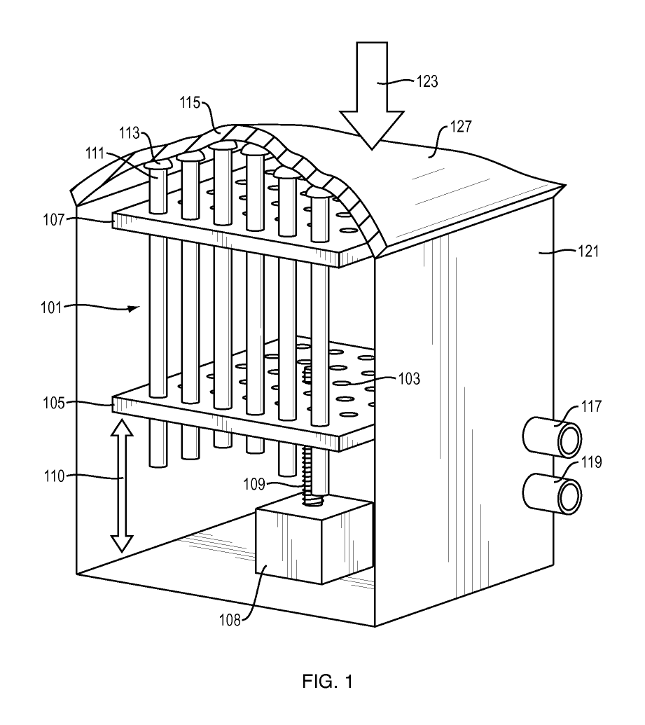

FIG. 1 shows an apparatus for creating a reconfigurable surface 127 defined by the position of a plurality of pins 101. The pins can be closely packed together and arranged at different heights to form the contours of the three-dimensional surface 127. The shape of the surface can also be defined by the spacing between the surfaces. An interpolation layer 115, such as a rubber layer, can be hardened over the pin configuration to form a mold. In instances in which an interpolation layer 115 is included, the interpolation layer can be melted or otherwise removed and the pins can be reconfigured into another design. Then the interpolation layer 115 can be reused, or another interpolation layer can be formed over the new design. In some instances, the interpolation layer can be made from a reconfigurable material that can reconfigure along with the movement of the pins.

Brakes can be used to lock the pins in a desired location to form the surface. In one embodiment the brake can include a heating element and a phase-changing liquid disposed around at least a portion of each of the pins. The heating element can be used to change the phase of the liquid such that when the liquid is in the liquid phase the pin can move and when the liquid is in the solid phase the pin can be locked in a desired position. A variety of heating elements can be used to heat and cool the liquid. In some embodiments they include resistors commensurate with respective pins, while in other embodiments the heating elements can be the pins themselves.

As shown in FIG. 1, the pins may have a tip (e.g., 113) that is wider than the main body of the pin (e.g., 111). These wide tips tend to smooth the interpolation layer 115, when the interpolation layer is pushed or pulled against the pins (e.g., by a vacuum). These tips also allow for more accurate resetting of the configuration between uses.

A brake layer 107 houses an array of brakes. The motion of each pin can be individually braked. Electronics are integrated into the brake layer 107 for control.

A movable layer 105 can simultaneously move all of the pins in the array 101 in a linear displacement 110. For example, if the pins are ferrite, the movable layer 105 may house magnets that can attract the pins sufficiently so that the pins press against the movable layer 105 and the pins tend to move with the movable layer 105.

The movable layer 105 is actuated by a motor 108 which transmits power to the movable plate via a lead screw 109. Alternately, any other linear actuation mechanism may be used to translate the movable layer 105.

The brake layer 107 has an array of brakes that can individually brake the respective pins. The braking force on a pin can overcome the actuating force on the pin provided by the moveable plate. For example, if a brake in the brake layer 105 engages one of the pins but not the others, then that one of the pins will stop moving while other pins continue to be moved by the movable layer 105. By braking different pins at different times as the movable layer moves the pins, the pins can be brought to a stop in a desired three dimensional pattern.

Vias (e.g., 103) penetrate the movable layer 105 and the brake layer 107. The pins 101 go through the vias. (In FIG. 1, only the front row of pins is shown. The remaining pins in the array are not shown).

In the example shown in FIG. 1, vacuum pressure is used to draw the interpolation layer 115 against the pins 101. The vacuum pressure may be created by using a vacuum pump to remove air from the sealed container 121 that houses the pins 101. The air may be removed through a vacuum port 117. Also, air may be released from the container 121 through an air release port 119. External pressure 123 (in addition to any vacuum pressure) may help hold the interpolation layer 115 against the pins 101. However, the use of a vacuum and interpolation layer is optional. In some implementations: (a) no vacuum is used, or (b) no interpolation layer is used.

In order to draw a vacuum through the device to pull down the interpolation layer, the whole structure needs to be air tight. To more readily detect holes, air may be blown into the structure (as a greater pressure difference is possible with positive pressure versus negative vacuum pressure). The holes may be sealed with gasketing or silicone sealant.

The interpolation layer 115 may comprise a low durometer (10 A Shore hardness) silicone rubber. This silicone is resistant to heat up to 600 degrees F., more than sufficient for use with many injection molded and vacuum formed materials. An added benefit of the reconfigurable geometry and the compliance of the silicone interpolation layer is that molds with a 90 degree relief angle are possible (in conventional molding, a sharp relief angle would prevent mold release).

The ratio of the diameter of the pin head 113 versus the diameter of the main shaft of the pin 111 can be greatly reduced by making the pin support structure (e.g., 107, 105) more densely packed.

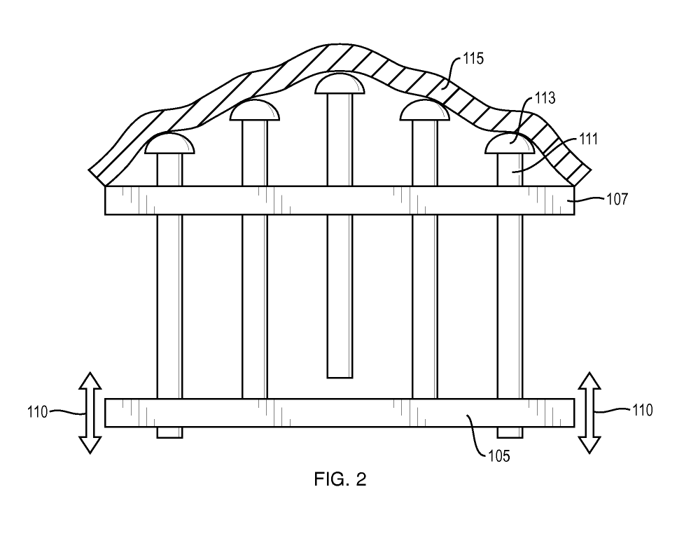

FIG. 2 shows a simplified side view of the same apparatus shown in FIG. 1.

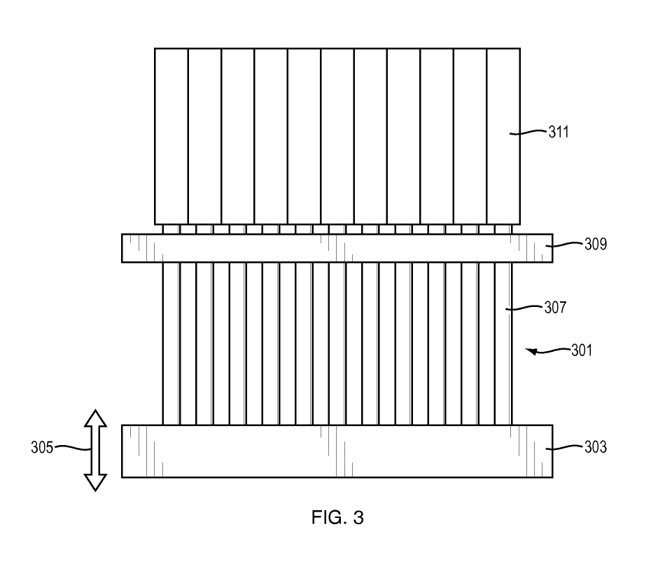

FIG. 3 shows a cross section of a pin positioning mechanism. An array of pins 301 is positioned using a moving plate 303 and simple, digitally controlled, pin gripping brakes. To generate a contoured surface, all of the micro-brakes are released and the plate is moved to the top of its stroke, near the brake array. The pins move along with the movable plate. Next, the plate, with all steel pins attached to it, moves downwards slowly. As the plate moves downwards, brakes are individually activated as their corresponding pins reach the correct height. When the plate reaches the bottom of its stroke, all the pins in the array will have been configured to form the desired topography. This design is advantageous as only one large actuation plate is required and the mold reconfiguration cycle can be short.

In some implementations of this invention, the pins comprise simple steel rods with press-fitted or dip-coated plastic sheaths. A single-axis moving stage controlled by stepper motor. An electrically controlled micro-brake fits in the area between the pins. In some implementations, this design can be scaled to very small pin sizes and can withstand forming pressures—which become less and less per pin as the array becomes higher resolution.

In some implementations of this invention: (a) pin array is scalable to sub-millimeter pin size, (b) the device is scalable to a large surface area, (c) the surface formed by the pin array can be completely reconfigured in 20 minutes or less, and (d) the device can withstand forming pressures of 300 psi or greater.

In some implementations of this invention: (a) Each brake takes up an area equivalent to the area inside the outer diameter of the pin sheath and outside the diameter of the steel rod center (limited in the x- and y-directions). However, there is little limitation to length of the brake along the throw of the pin (unlimited in z-direction). (b) Due to the large number of braking elements, electronic control is used to ensure accurate and repeatable braking (c) Each brake has a sufficient holding force to allow the array to resist forming pressures of 300 psi or greater. (d) Brakes actuate fast enough to allow the array to reconfigure in less than 20 minutes.

In some implementations of this invention, each brake includes a phase-changing component, such as a low melt alloy or other low melt metal. Advantageously, a phase changing alloy can provide strong gripping force—potentially equal to the shear force of the alloy used.

For example, each brake may comprise a solder type alloy that coats a threaded lead screw or notched rod. The alloy rigidly locks the threaded screw or notched rod in place when the alloy solidifies. Different resistive heating elements may used to change phase, such as a through-hole resistor, a nickel chromium wire, or the steel pin itself.

In an early prototype of this invention, two PCB's sandwich a piece of laser-cut delrin. Threads on a steel threaded rod are coated with Cerrolow 117, low melt solder. The rod has a PTFE (polytetrafluoroethylene) sheath near the top of the rod. A 900 Ohm resistor is inserted in parallel, near the threaded rod, electrically insulated from the low melt alloy by a neoprene spray coating. At the scale used in this prototype, the brake has a calculated holding force of around 20 pounds per pin (calculated from the estimated shear strength of the cylinder of solder surrounding the threaded rod, captured in the brake array). This equates to over 1,000 psi per square inch of holding force in the ⅛″ pin array. In reality, the rod can hold more than that (e.g., a 25 pound weight was hung from the pin successfully).

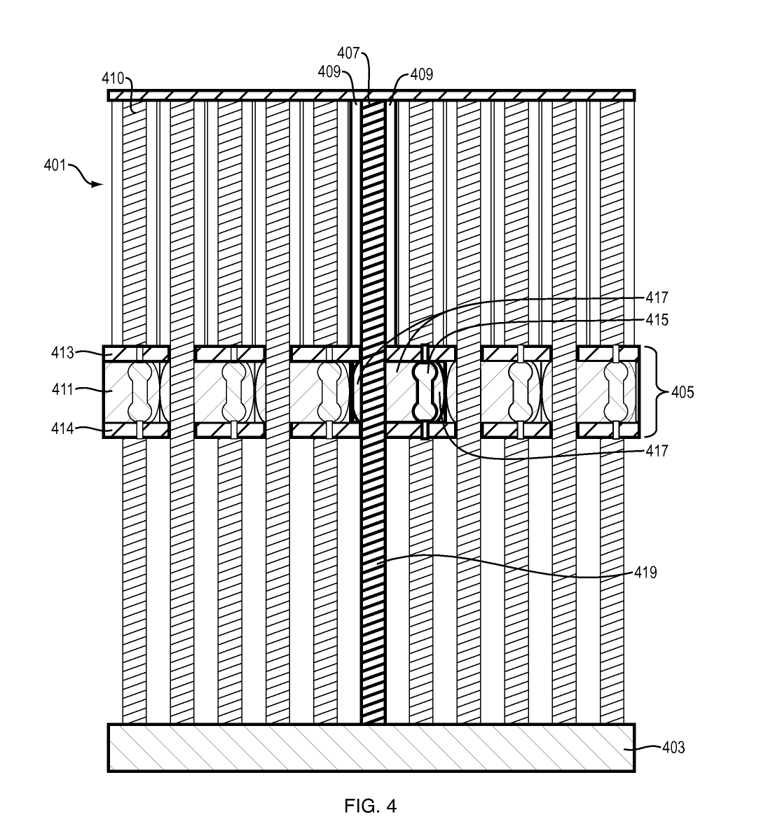

FIG. 4 shows a cross sectional view of a rod positioning apparatus that uses phase-changing brakes. In these brakes, a low melt alloy changes phase between solid and liquid during operation of the apparatus. When the alloy in a brake is solid, it causes a rod to stop moving. When it is liquid, it does not stop the rod.

In the example shown in FIG. 4, an array of steel threaded rods 401 is actuated by a magnetic plate 403. Motion of the magnetic plate 403 causes the rods to move through holes in the brake layer 405, except to the extent that any particular rod is individually braked by a brake in the brake layer 405.

The brake layer 405 houses an array of brakes for individually and selectively braking the rods. The brake layer 405 comprises two PCB layers 413, 414 that surround an acetyl center 411. For ease of illustration, one of the rods 407 and one of the brakes are emphasized with dark lines in FIG. 4. The steel brake comprises a resistive heating element 415 for heating a low melt alloy 417. The low melt alloy coats the steel threaded rod 407. The heaviest coating is in the threads of the rod 407. An upper portion of the steel threaded rod 407 is covered by a PTFE sheath 409. Each of the other rods in the array (e.g., rod 410) also has a low melt alloy brake housed in the brake layer 405.

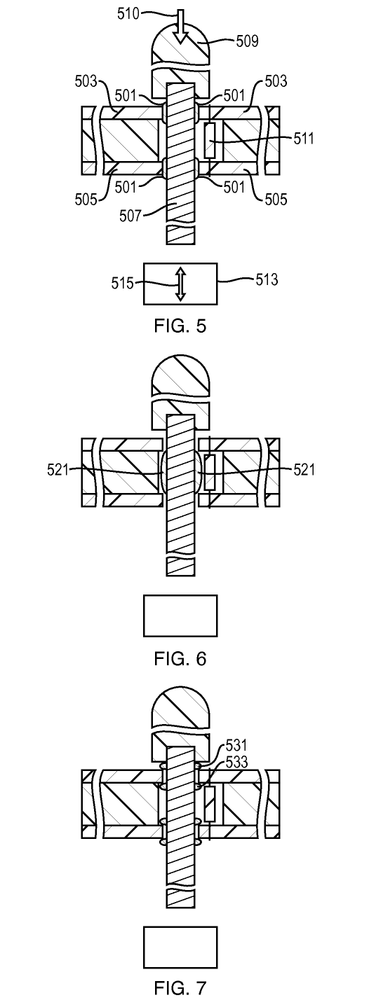

FIGS. 5, 6 and 7 show three examples of how solder in a brake can adhere the threaded pin to a PCB.

In FIG. 5, the solder is able to wet to the plating in the PCB and locks up the pin when the solder solidifies. In FIG. 5, a pin comprises a steel rod 507 that is coated with solder. At the top of the pin, the steel rod 507 is covered with a plastic sheath 510. Two PCB's 503, 505 sandwich a plastic core. A resistor 511 heats the solder. The solder 501 wets to the plating in the PCBs 503, 505, and locks up the steel rod 507 when the solder solidifies.

FIG. 6 shows an example where the solder 521 does not wet the PCBs, but beads up sufficiently to lock the pin in place when the solder 521 solidifies.

FIG. 7 shows a different example, where the solder (e.g., 531, 533) does not wet the PCBs, but beads up sufficiently to lock the pin in place when the solder solidifies.

Advantageously, a fusible alloy brake is very simple to manufacture. PCB's can be made for low cost. Threaded steel rod is inexpensive to buy or make, and a single axis linear actuator can be made for low cost as well.

An array of pins may be coated with a low melt alloy by dip coating (dipping the pins in the alloy when the alloy is liquid).

In a prototype of this invention, an array of fusible alloy brakes is used. In this prototype, a low resolution PCB of 52 pins with 0.3″ center to center spacing (hexagonally packed) was made by etching a single layer board. This PCB featured through holes for the threaded pins, plated holes with traces for the resistors and other smaller holes spread evenly on the surface to allow for vacuum to be drawn around the pins. This vacuum pressure can be used to hold down the rubber interpolation layer and smooth the pins. These holes can also be used for forced air cooling of the array, helping to get rid of heat buildup over time.

In a different prototype of this invention, a high resolution PCB was employed. This array has not one but six layers. Because of the layering, the number of pins could be quadrupled, and all the necessary electronics to control the array could be integrated directly onto the board, saving assembly time. A problem with the multi-layer PCB method is that the number of layers in the PCB increase as the board gets larger in the −x and −y dimensions. The number of layers increases because the traces required to provide power to the resistors throughout the board have to be of a minimum width to provide sufficient current carrying capacity, and additional layers are needed to handle the additional tracing.

In a prototype of this invention, pins were made from 2-56 threaded steel rods, with plastic rod threaded onto the end for a sheath. The threads are important for the adhesion of the solder, and steel is an advantageous material due to its superior stiffness. Pin sheaths were made from PTFE for both its low friction and high melting temperature—making it a preferred choice in a thermoforming device.

Preferably, the low melt solder should wet the surface of the steel rods thoroughly. Thorough wetting is preferable for the function of the solder brake, as solder may rub off the rod if wetting is poor. To improve the wetting of the rod, all oils were removed from the surface with acetone before dipping in the low melt solder. Observing how well copper wets on PCBs, a clean threaded rod was electroplated with a thin layer of copper and then dip coated with low melt solder. The copper coating offered excellent wetting—the solder was pulled deep into the threads and was quite difficult to rub off, even when pushed through a tight fitting hole. Advantageously, copper plating is inexpensive. Alternately, other surface coatings (instead of copper) for the rod may be employed.

An advantage of a threaded rod, as compared to a smooth rod, is that a threaded rod exhibits much better wetting of the solder. This difference apparently results from solder “wicking” into the threads of the rod. However, in some implementations of this invention, smooth rods (without threads) are used.

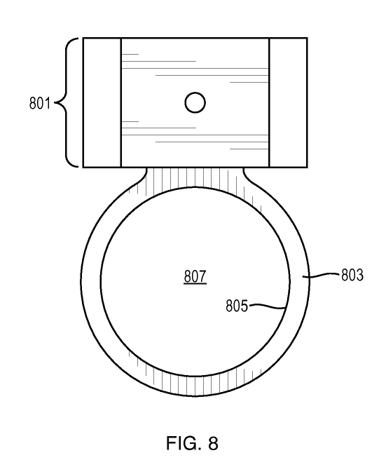

FIG. 8 shows an example of a through hole (via) 807 for a pin. The hole 807 goes through a PCB. The hole 807 is surrounded by a heat sink 803 that is copper plated on its interior surface 805. The heat sink 803 receives heat from a resistor 801.

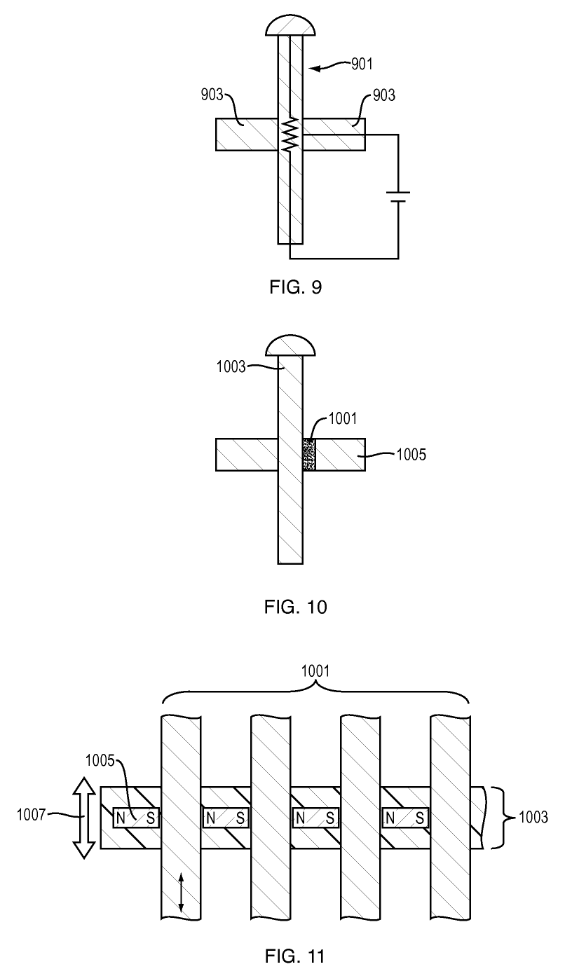

FIG. 9 shows an example where the pin itself is the heating element. A resistor is embedded in the pin 901. The pin 901 goes through a via in a PCB 903.

Optionally, one or more sensors may be used to monitor temperature of the brake. For example, as shown in FIG. 10, a temperature sensor 1001 may be included in a PCB 1005 to monitor the temperature of a fusible alloy brake. The temperature detected by the sensor indicates whether or not the fusible alloy is solid, and thus whether or not the pin is locked by the brake.

In some implementations of this invention, a magnetic plate attracts the steel pins and pulls them down. The strength of the magnet should be sufficient to pull each rod along, but not so strong that the rod won't be able to be pulled off the magnet when the brake is activated. A single large square magnet may be used for this purpose. However, a single large magnet tends to produce a rotation moment on many of the steel rods. The further away from the center of the magnet, the magnetic field lines were more curved—this effect puts a rotation force on the rods and makes them difficult to pull straight down. To remedy this, the single, large magnet may be replaced by an array of smaller magnets with one installed at the base of each pin. This method works well, as the magnets provided a centering effect on the rods if they became misaligned.

FIG. 11 shows an example of a magnetic moving plate 1003 for moving an array of ferrite pins 1001. The plate includes an array of magnets (e.g., 1005). The magnets may be either permanent or electromagnetic. The ferrite pins 1001 press against the plate 1003 due to magnetic attraction to the magnets. When the plate moves in a linear displacement 1007, the ferrite pins 1003 move along with the plate 1005, unless the pins are braked by the brakes. This invention is not, however, limited to use of a magnet. As is apparent to a person skilled in this art, motion may be transmitted from the moving plate to the pins in many different ways.

This invention is not limited to brakes that employ phase-changing components. For example, thermally actuated brakes may be employed instead. These brakes change shape as the temperature changes (e.g., buckle or bend as the temperature increases). The change in shape due to thermal expansion or contraction causes the brake to engage or disengage with the pin.

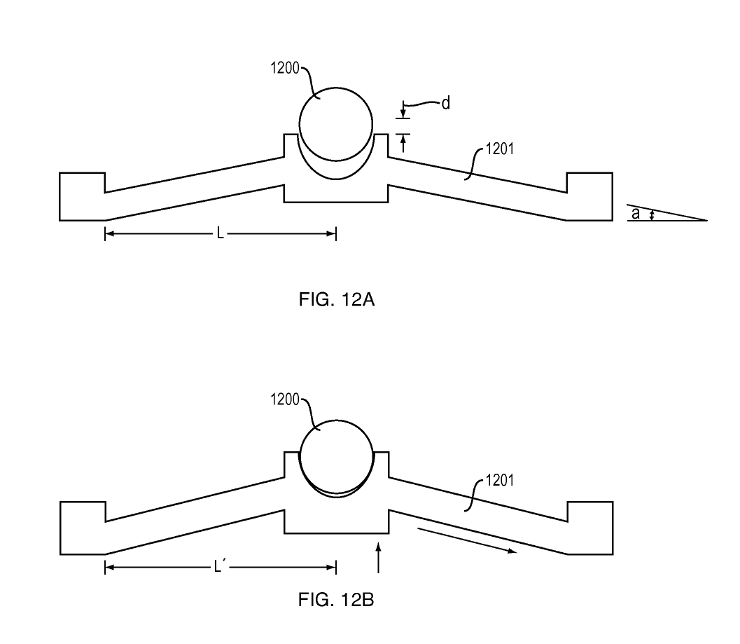

In some implementations of this invention, each of the brakes comprises a thermally buckling chevron beam. When the beam buckles, it engages with, and locks in place, a steel threaded rod. In the example shown in FIGS. 12A and 12B, the crescent-moon shaped part of the chevron beam 1201 is threaded. Upon heating the beam to about 200 degrees C., the flexure buckles enough to engage the threads of the pin 1200, locking the pin in place.

FIG. 12A shows the unheated chevron beam brake before heating. In FIG. 12A, the chevron beam is not in contact with the pin. FIG. 12B shows the brake after heating. In FIG. 12B, the threaded rod is engaged and locked in place by the chevron beam brake. The chevron beam has buckled toward the pin because of thermal expansion.

The following equation may be used to approximate the displacement d needed for the chevron brake:

d=[L²+2(L)(L′)−cos(α)²]^{1/2}−Lsinα
where L is the unheated single beam length, L′ is heated single beam length, and a is the unheated beam.

For a prototype of this invention, an array of chevron beam brakes was fabricated as follows: The array was first partially cut out with an abrasive water-jet, and then the threads in the center of each flexure were tapped. The thin flexures were milled out. Electrical traces and resistive heaters were placed on the flexures as follows: First, the aluminum flexure was anodized, to make it electrically insulated. Next, conductive paint was sprayed on over a laser-cut stencil to make a base for further electroplating. Copper was then electroplated on the conductive paint and high-resistance carbon paint was applied to the flexure to allow for direct heating of the flexures by resistive heating. The micro-machine array included fins along the perimeter to prevent the array from uniformly heating and thereby reducing the effects of thermal actuation of individual chevron brakes. The array was made from 6061 aluminum stock.

The shape of a thermally actuated brake is not limited to a chevron, but can be other shapes, such as irregular shapes, that buckle or deflect when heated.

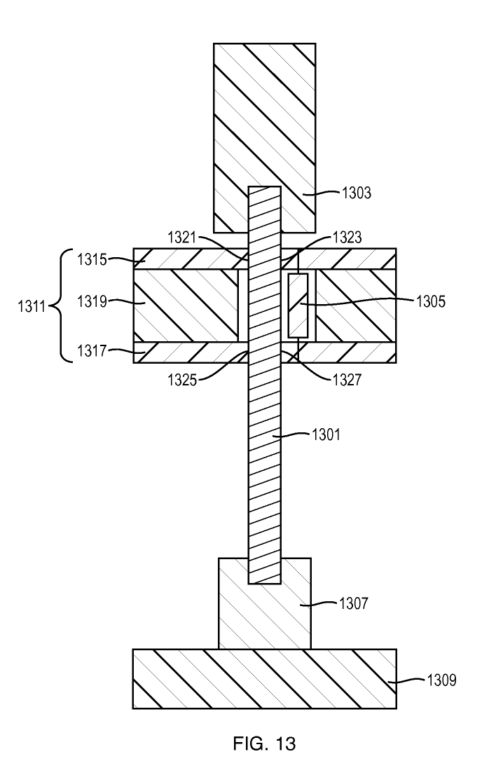

In some implementations of this invention, the pins themselves comprise the electrical transmission lines through which their corresponding resistor heater receives power. FIG. 13 illustrates this. In the example shown in FIG. 13, the top of an electrified steel rod 1301 is covered by a plastic sheath 1309. A resistor 1305 is embedded in an upper PCB 1311. The upper PCB 1311 comprises two PCB layers 1315, 1317 surrounding a plastic core 1319. Controlling electronics can be placed in the plentiful space below the z-movement stage and provide power through the pin 1301 via the pin's contact with a gold-plated conductive magnet 1307. The upper PCB 1311 can transfer power to a resistor 1305 from the connection made by the solder on the electrified steel rod 1301 to the metal plated edges 1321, 1323, 1325, 1327 of the holes around it. By making the entire lower PCB 1309 a ground common, this completes the circuit. Advantageously, this approach allows the pin array to be easily scaled in the −x and −y dimensions.

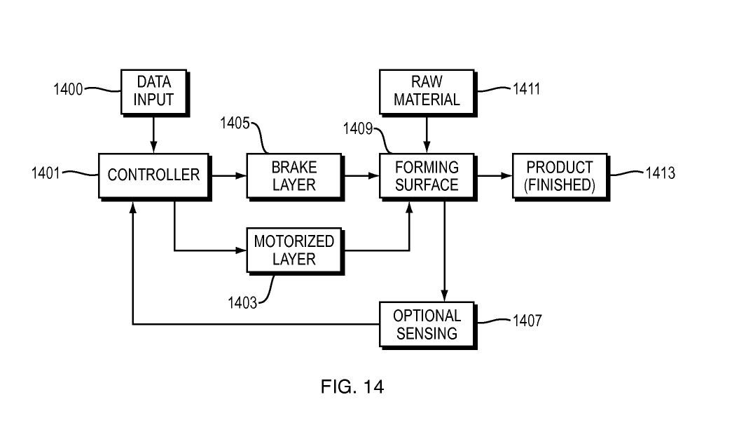

FIG. 14 is a high level block diagram of a pin-positioning apparatus for creating a forming surface. A controller 1401 receives data input 1400 regarding a desired three dimensional surface. The controller 1401 generates control signals to control the motion of a motorized layer 1403. The motorized layer 1403 can move all of the pins in an array of pins simultaneously (when none of the brakes are engaged).

A brake layer 1405 comprises an array of brakes for individually and selectively braking the respective pins in the pin array. The controller 1401 also generates control signals for controlling when the individual brakes in the brake array engage or disengage their respective pins. When a brake engages a pin, the pin stops moving, even if the motorized layer 1403 and the rest of the pins continue to move.

By controlling the motion of the motorized layer 1403 and timing of when the respective brakes stop their respective pins from moving, the controller 1401 can cause the pins to be arranged in a particular 3D pattern when all of the pins come to a halt. When the pins are in this particular 3D pattern, the tips of the pins (or the interpolation layer, if there is one) are each points in the desired three dimensional surface.

Optional sensing 1407 may be used to detect sensor data. For example, the sensor data may be indicative of pin position (or distance actuated). Or, for example, the sensor data may be indicative of the temperature of a brake. For instance, a temperature sensor may detect that a brake has a low temperature. The controller may accept data indicative of this low temperature reading, and may determine, based on this data, that a low melt alloy in a brake has solidified and locked a pin in position.

A forming surface 1409 may be a positive or negative impression of the particular 3D pattern. Raw material 1411 may used to create a finished product that has a shape that conforms to the shape of the forming surface 1409 (e.g., as a positive or negative impression of the shape).

This invention may be implemented with many different kinds of brakes. For example, the brake layer 1405 may house piezoelectric brakes, electromagnetic brakes (e.g., ferrous pins with electromagnetic brake or vice versa), hydraulic or pneumatic brakes (e.g., microfluidic channels, with piston actuation), electrorheological or magnetorheological brakes, acoustic brakes (e.g., tuned resonance), or electrostatic brakes (e.g., a comb drive or capacitor in MEMS). Or, for example, the brake layer 1405 may house an array of brakes, in which (a) each brake uses thermal expansion or contraction of that individual brake to engage of disengage that brake, or (b) direct radial thermal expansion of pins is used to statically secure an entire array). Or, for example, brakes in the brake layer 1405 may employ a shape memory alloy or phase changing materials (e.g., low melt alloy in brake region or coating pin).

In some implementations of this invention, braking is performed in two steps. The first step is the configuration of pins via a lower force method of individual braking (as described above) with the second step being a higher force locking mechanism applied to the whole array to prepare the array for a high force application (such as compression molding). To grip pins as an array, force could be applied from the sides (static indeterminacy could be circumvented by using straight rows of pins, rather than hexagonal or other pin arrangements), a magnetic or electrical field could be applied to the array to pull all pins to each other, phase changing material could be poured over a whole area of the grid, locking the area in place, or a flexible sac of small grain material (like sand or powder) could be placed on the tops of the pins and vacuum internally applied to it, to pack the material together and harden the sac into a useful forming surface.

The controller 1401 may comprise one or more computer processors. Depending on how this invention is implemented, the number, type, and location of these processors may vary, and the way in which these processors are interconnected may vary. For example, the processors may be integrated into a brake assembly, or a moveable plate. Or, for example, some of the processors may be remote from the pin positioning apparatus. The processors may be connected to each other and to other electronic components by wired or wireless connections.

In some implementations of this invention, closed-loop control of the pin array is achieved by incorporating sensors that supply feedback on each pin's position. For example, the pins themselves can be used as linear potentiometers (each pin's position would correlate to a specific resistance measured across that pin). Or, for example, a laser beam break sensor and high accuracy laser interferometry can be used to measure pin position. To sense the heating of each pin (if a thermally dependent brake was used) the heating elements can also be used as thermistors to measure their temperature as a function of their dynamic resistance.

Through-hole resistors were used in some of the prototypes to alter the phase-state of the low melt solder. However, other heating methods are possible (such as direct resistive heating of the pin itself).

For a phase changing brake based device, resistive heating elements can be placed near low-melt alloy coated pins to allow them to slide when the heating was turned on and freeze in place when the power was off. The low melt alloy itself can be used as the resistive heating element if alloyed properly, or the pin can be a resistor and heat the low melt alloy from inside. Other phase changing alloy melting techniques can be employed, such as melting via a distributed laser heating array or a phased electromagnetic heating method (like a conventional microwave).

For the movement of the pin matrix, a moving magnetic plate with a small magnet correlated to each iron/steel pin can improve flux return (a single large magnet with only two poles would have poor magnetic attraction to single pins). Along with magnetic attraction, vacuum pressure (or positive pressure from above), inchworm stepper motors or a tuned electromagnetic field can conceivably be used for mass pin movement. Also, tuning each pin to a specific resonant frequency and vibrating the array with a multi-sinusoidal input signal would allow for vibration controlled movement of many pins from a single input embedded with many sinusoids.

In exemplary embodiments of this invention, a pin-positioning apparatus is used to create a reconfigurable surface. The reconfigurable surface has many practical applications. Among other things, in some embodiments, the surface can be used to form an injection or vacuum mold. For example, a first surface can be formed, one or more injection or vacuum molds can be formed from that first surface, and then the first surface can be altered to create a second surface that has a different shape. The second surface can subsequently be used to form another injection or vacuum mold(s).

In some implementations of this invention, the brakes release the pins at different times. After the different pins are released, the released pins begin to move due to a force applied by a moving actuator plate, while the pins that have not yet been released do not move. When the movable plate has completed its stroke, the pins are positioned in a desired 3D arrangement.

In some implementations, a row plus column addressing method in used. In these implementations, a resistor and a diode are used for each pin. The heating elements are actuated one row at a time, and only specified columns of that row. Therefore each active heating element is quickly transitioning between being on and off, but the physical characteristics of the invention essentially time average this to being equivalent to being continuously on. The row plus column addressing method then only requires one driving circuit per row and one driving circuit per column. In sufficiently large arrays this is substantially less driving circuits than if one was to use an entire driving circuit per pin. Since driving circuits are more expensive/larger/complicated than a mere diode plus resistor, this decreases costs and increases scalability.

### Variations

This invention may be implemented in many different ways. Here are some non-limiting examples.

This invention may be implemented as a device for creating a reconfigurable surface, comprising: a plurality of pins; a pin actuator configured to move one or more pins of the plurality of pins between an initial position and a plurality of settled positions, at least some of the settled positions being different for some of the one or more pins; and a brake for stopping the one or more pins at the respective settled positions. The pin actuator may further comprise: a base plate; and an actuation device coupled to the base plate and configured to raise and lower the base plate to move the one or more pins between the initial position and the plurality of settled positions. The plurality of pins and the base plate may be magnetic. The base plate may comprise two or more base plates. A proximal end of the one or more pins may be larger than a distal end of the one or more pins. At least a portion of the one or more pins may comprise notches. The device may further comprise one or more sensors to determine a position of one or more of the pins. The spacing between each of the plurality of pins may be approximately in the range of about 0.2 millimeters to about 5 millimeters. The spacing between each of the plurality of pins may be about 3 millimeters or less. The spacing between each of the plurality of pins may be about 0.5 millimeters. The diameter of at least a portion of the pin may be approximately in the range of about 0.2 millimeters to about 5 millimeters. The diameter of at least a portion of the pin may be about 3 millimeters. The diameter of at least a portion of the pin may be about 0.5 millimeters. The brake may further comprise: a heating element; and a phase-changing liquid disposed around at least a portion of each of the plurality of pins, the phase-changing liquid having a liquid phase in which the pin around which the liquid is disposed is substantially mobile and a solid phase in which the pin around which the liquid is disposed is substantially stationary, wherein the heating element is operable to change a phase of the phase-changing liquid between the liquid phase and the solid phase. The phase-changing liquid may be a low melt alloy having a melting point that is less than or equal to about 150 degrees Celsius.

The heating element may be spaced a distance apart from the pin actuator and may be configured to move in conjunction with the pin actuator. The heating element may be disposed on a base plate of the pin actuator. The heating element may further comprise a plurality of resistors. Each pin of the plurality of pins may have its own resistor from the plurality of resistors. When the heating element is powered on, the phase-changing liquid adjacent to the heating element may be substantially in the liquid phase and when the heating element is powered off, the phase-changing liquid adjacent to the heating element may change substantially to the solid phase. The device may further comprise one or more sensors to measure a temperature of at least one of the phase-changing liquid and one or more of the pins to determine a position of the one or more pins. One or more of the plurality of pins may comprise the heating element. The brake may further comprise a plurality of bi-stable flexures, each flexure being disposed around at least a portion of one of the plurality of pins and being configured to lock the respective pin in the settled position of the pin. The device may further comprise an interpolation applicator for applying a material to a proximal end of the plurality of pins to form an interpolation layer. The material may comprise rubber. The device may further comprise a surface locker for maintaining the settled positions for each of the plurality of pins to form a set surface. The device may further comprise a design input controller configured to control operation of the pin actuator and the brake to provide a particular surface design.

This invention may be implemented as a method for creating a surface, comprising: positioning a plurality of pins in an initial position; moving the plurality of pins toward desired settled positions; and selectively locking pins of the plurality of pins in the desired settled positions such that when each of the pins is positioned at its respective desired settled position, a desired surface is formed. The initial position may be proximal with respect to at least one of the desired settled positions. The selectively locking pins of the plurality of pins may further comprise locking each of the pins individually. The selectively locking pins of the plurality of pins may further comprise changing a phase of a liquid disposed around at least a portion of the pin. The method may further comprise measuring a temperature of at least one of the liquid and one or more of the pins to determine a position of the one or more pins. The method may further comprise measuring a position of one or more pins of the plurality of pins. Selectively locking pins of the plurality of pins may further comprise operating a mechanical flexure disposed around at least a portion of the pin. Moving the plurality of pins may further comprise moving a base plate disposed distal to the plurality of pins in a distal direction. The plurality of pins may be magnetically coupled to the base plate. The desired surface may be three-dimensional. The method may further comprise applying an interpolation layer to the plurality of pins. The method may further comprise: melting at least a portion of the interpolation layer; repositioning at least one of the pins of the plurality of pins to form a new desired surface. The method may further comprise applying a locking force to the plurality of pins after the pins are locked in their desired settled positions to form a set surface. The method may further comprise inputting a particular surface design to determine the desired settled positions for the pins of the plurality of pins.

This invention may be implemented as a device for creating an injection mold, comprising: a plurality of pins; a base plate configured to move one or more pins of the plurality of pins; a brake for stopping one or more pins at a desired position; and a liquid injector for injecting a material along a surface formed by proximal ends of the plurality of pins to form a production mold. The brake may further comprise: a heating element; and a phase-changing liquid disposed around at least a portion of each of the plurality of pins, the phase-changing liquid having a liquid phase in which the pin around which the liquid is disposed is substantially mobile and a solid phase in which the pin around which the liquid is disposed is substantially stationary, wherein the heating element is operable to change a phase of the phase-changing liquid between the liquid phase and the solid phase.

This invention may be implemented as a method for forming an injection mold, comprising: moving a plurality of pins from an initial position to a plurality of settled positions; selectively locking pins of the plurality of pins at their respective settled positions to form a contoured surface; and injecting a material along the contoured surface to form an injection mold therefrom. The method may further comprise applying an interpolation layer to the plurality of pins. Selectively locking pins of the plurality of pins may further comprise changing a phase of a liquid disposed around at least a portion of the pin.

This invention may be implemented as a device for creating a vacuum mold, comprising: a plurality of pins; a base plate configured to move one or more pins of the plurality of pins; a brake for stopping one or more pins at a desired position; and a liquid injector for injecting a material along a surface formed by proximal ends of the plurality of pins to form a production mold. The brake may further comprise: a heating element; and a phase-changing liquid disposed around at least a portion of each of the plurality of pins, the phase-changing liquid having a liquid phase in which the pin around which the liquid is disposed is substantially mobile and a solid phase in which the pin around which the liquid is disposed is substantially stationary, wherein the heating element is operable to change a phase of the phase-changing liquid between the liquid phase and the solid phase.

This invention may be implemented as a method for forming a vacuum mold, comprising: moving a plurality of pins from an initial position to a plurality of settled positions; selectively locking pins of the plurality of pins at their respective settled positions to form a contoured surface; injecting a material along the contoured surface to form a vacuum mold therefrom. The method may further comprise applying an interpolation layer to the plurality of pins. Selectively locking pins of the plurality of pins may further comprise changing a phase of a liquid disposed around at least a portion of the pin.

This invention may be implemented as apparatus comprising, in combination: (a) at least one actuator for moving a plurality of rods, and (b) a plurality of brakes, wherein each one of the brakes, respectively, includes a component that is adapted to change phase between liquid and solid during operation of the apparatus, is adapted, when solid, to adhere to one of the rods and to stop motion of that one of the rods relative to that one of the brakes, and is adapted, when liquid, to not stop the motion. Furthermore: (1) a single one of the at least one actuators may be adapted to move multiple ones of the rods simultaneously when none of the brakes for the multiple rods are engaged; (2) the component may have a melting point that is less than 200 degrees Celsius; (3) the apparatus may further comprise heating elements for controlling the temperature of each of the brakes, respectively, which temperature may differ from brake to brake; (4) at least one of the rods may include at least one of the heating elements; (5) at least one of the heating elements is positioned outside of the rods; and (6) at least two of the heating elements may be located in a single printed circuit board, and at least two of the rods may be adapted to move through holes in the printed circuit board.

This invention may be implemented as apparatus comprising, in combination: (a) at least one actuator for moving a plurality of parts, (b) a plurality of brakes, and (c) at least one processor for accepting data that is indicative of a three dimensional surface, and for generating temperature control signals to control the temperature of each of the brakes, respectively, which temperature control signals cause the respective brakes to stop or release the respective parts at different times, such that when all of the parts have stopped moving, the parts are in a spatial pattern, wherein, when the parts are in the spatial pattern, at least one exterior point in each of the parts, respectively, lies in the three dimensional surface. Furthermore: (1) a single one of the at least one actuators may be adapted to move multiple ones of the parts simultaneously when none of the brakes for the multiple parts are engaged; (2) each one of the brakes, respectively, may be adapted to undergo a displacement toward or away from one of the parts, which displacement determines whether or not that one of the brakes is in physical contact with that one of the parts, and which displacement is due to thermal expansion or thermal contraction; (3) an angle between two solid, elongated parts of the respective brakes may vary depending on the temperature of the elongated parts; (4) the respective brakes may be adapted to change shape, instead of merely expanding or contracting, depending on the temperature of the respective brakes; (5) each one of the brakes, respectively, may include a phase-changing component that is adapted to change phase between liquid and solid during operation of the apparatus, is adapted, when solid, to adhere to one of the parts and to stop motion of that one of the parts relative to that one of the brakes, and is adapted, when liquid, to not stop the motion; (6) the phase-changing component may have a melting point that is less than 150 degrees Celsius; (7) the apparatus may further comprise heating elements for controlling the temperature of the brakes, respectively, which temperature may differ from brake to brake; (8) at least one of the parts may include at least one of the heating elements; and (9) at least two of the heating elements may be located in a single printed circuit board, and at least two of the parts may be adapted to move through holes in the printed circuit board.

This invention may be implemented as a method of positioning a plurality of parts in a pattern in which at least one exterior point in each of the respective parts lies in a three dimensional surface, the method comprising, in combination: (a) at least one processor accepting data indicative of the surface, (b) an actuator for moving a plurality of parts, and (c) the at least one processor generating temperature control signals to control the temperature of each of a plurality of brakes, respectively, which temperature control signals cause the respective brakes to stop or release the respective parts at different times, such that when all of the parts have stopped moving, the parts are in positions that define the three dimensional pattern. Furthermore: (1) each one of the brakes, respectively, may be adapted to undergo a displacement toward or away from one of the parts, which displacement determines whether or not that one of the brakes is in physical contact with that one of the parts, and which displacement is due to thermal expansion or thermal contraction; and (2) each one of the brakes, respectively, may include a phase-changing component that is adapted to change phase between liquid and solid during operation of the apparatus, is adapted, when solid, to adhere to one of the parts and to stop motion of that one of the parts relative to that one of the brakes, and is adapted, when liquid, to not stop the motion.

### Definitions and Clarifications:

Here are a few definitions and clarifications. As used herein:

The terms “a” and “an”, when modifying a noun, do not imply that only one of the noun exists.

When one or more examples are given, they are non-limiting. Other examples may exist. The examples that are given are not intended to be exhaustive.

The term “include” shall be construed broadly, as if followed by “without limitation”.

A point is “in a three dimensional surface” if and only if the surface intersects that point.

Data is “indicative of a three dimensional surface” if it directly or indirectly specifies or indicates all or part of that surface. For example, a set of points in a specified 3D surface would be indicative of the specified 3D surface. Or, for example, data indicative of another surface mapped to the specified 3D surface is indicative of the specified 3D surface. Or, for example, data indicative of the three dimensional positioning of an array of objects is indicative of the specified 3D surface, if the positioning is mapped to the specified 3D surface.

The term “or” is an inclusive disjunctive. For example “A or B” is true if A is true, or B is true, or both A or B are true.

A parenthesis is simply to make text easier to read, by indicating a grouping of words. A parenthesis does not mean that the parenthetical material is optional or can be ignored.

Two values are “substantially” equal if they differ by less than 10%.

Two values differ “substantially” if they differ by 10% or more.

Two values differ by a certain percent, if [(x−y)/x]×100 equals that certain percent, where x is the larger of the two values and y is the smaller of the two values.

### Conclusion

It is to be understood that the methods and apparatus which have been described above are merely illustrative applications of the principles of the invention. Numerous modifications may be made by those skilled in the art without departing from the scope of the invention. The scope of the invention is not to be limited except by the claims that follow.

What is claimed is:

1. Apparatus comprising, in combination:
at least one actuator for moving a plurality of rods, and a plurality of brakes,
wherein each one of the brakes, respectively, includes a component that is adapted to change phase between liquid and solid during operation of the apparatus,
is adapted, when solid, to adhere to one of the rods and to stop motion of that one of the rods relative to that one of the brakes, and
is adapted, when liquid, to not stop the motion.

2. The apparatus of claim 1, wherein a single one of the at least one actuators is adapted to move multiple ones of the rods simultaneously when none of the brakes for the multiple rods are engaged.

3. The apparatus of claim 1, wherein the component has a melting point that is less than 200 degrees Celsius.

4. The apparatus of claim 1, wherein the apparatus further comprises heating elements for controlling the temperature of each of the brakes, respectively, which temperature may differ from brake to brake.

5. The apparatus of claim 4, wherein at least one of the rods includes at least one of the heating elements.

6. The apparatus of claim 4, wherein at least one of the heating elements is positioned outside of the rods.

7. The apparatus of claim 4, wherein at least two of the heating elements are located in a single printed circuit board, and at least two of the rods are adapted to move through holes in the printed circuit board.

8. Apparatus comprising, in combination:
at least one actuator for moving a plurality of parts,
a plurality of brakes, and
at least one processor
for accepting data that is indicative of a three dimensional surface, and
for generating temperature control signals to control the temperature of each of the brakes, respectively, which temperature control signals cause the respective brakes to stop or release the respective parts at different times, such that when all of the parts have stopped moving, the parts are in a spatial pattern,
wherein, when the parts are in the spatial pattern, at least one exterior point in each of the parts, respectively, lies in the three dimensional surface.

9. The apparatus of claim 1, wherein a single one of the at least one actuators is adapted to move multiple ones of the parts simultaneously when none of the brakes for the multiple parts are engaged.

10. The apparatus of claim 8, wherein each one of the brakes, respectively, is adapted to undergo a displacement toward or away from one of the parts, which displacement determines whether or not that one of the brakes is in physical contact with that one of the parts, and which displacement is due to thermal expansion or thermal contraction.

11. The apparatus of claim 9, wherein an angle between two elongated parts of each of the respective brakes varies depending on the temperature of the elongated parts.

12. The apparatus of claim 9, wherein the respective brakes may be adapted to change shape, instead of merely expanding or contracting, depending on the temperature of the respective brakes.

13. The apparatus of claim 8, wherein each one of the brakes, respectively, includes a phase-changing component that
is adapted to change phase between liquid and solid during operation of the apparatus,
is adapted, when solid, to adhere to one of the parts and to stop motion of that one of the parts relative to that one of the brakes, and
is adapted, when liquid, to not stop the motion.

14. The apparatus of claim 12, wherein the phase-changing component has a melting point that is less than 150 degrees Celsius.

15. The apparatus of claim 12, wherein the apparatus further comprises heating elements for controlling the temperature of the brakes, respectively, which temperature may differ from brake to brake.

16. The apparatus of claim 15, wherein at least one of the parts includes at least one of the heating elements.

17. The apparatus of claim 15, wherein at least two of the heating elements are located in a single printed circuit board, and at least two of the parts are adapted to move through holes in the printed circuit board.

18. A method of positioning a plurality of parts in a pattern in which at least one exterior point in each of the respective parts lies in a three dimensional surface, the method comprising, in combination:
at least one processor accepting data indicative of the surface,
an actuator for moving a plurality of parts, and
the at least one processor generating temperature control signals to control the temperature of each of a plurality of brakes, respectively, which temperature control signals cause the respective brakes to stop or release the respective parts at different times, such that when all of the parts have stopped moving, the parts are in positions that define the three dimensional pattern.

19. The method of claim 18, wherein each one of the brakes, respectively, is adapted to undergo a displacement toward or away from one of the parts, which displacement determines whether or not that one of the brakes is in physical contact with that one of the parts, and which displacement is due to thermal expansion or thermal contraction.

20. The apparatus of claim 18, wherein each one of the brakes, respectively, includes a phase-changing component that
is adapted to change phase between liquid and solid during operation of the apparatus,
is adapted, when solid, to adhere to one of the parts and to stop motion of that one of the parts relative to that one of the brakes, and
is adapted, when liquid, to not stop the motion.
